(19) United States
(12) Patent Application Publication
(10) Pub. No.: US 2024/0029132 A1
(43) Pub. Date: Jan. 25, 2024

(54) ATTRIBUTE SCHEMA AUGMENTATION WITH RELATED CATEGORIES

(71) Applicant: Maplebear Inc. (dba Instacart), San Francisco, CA (US)

(72) Inventors: Shih-Ting Lin, Santa Clara, CA (US); Amirali Darvishzadeh, Laguna Niguel, CA (US); Min Xie, Santa Clara, CA (US); Haixun Wang, Palo Alto, CA (US)

(21) Appl. No.: 17/868,572

(22) Filed: Jul. 19, 2022

(51) Int. Cl. G06Q 30/06; G06F 40/20

(52) U.S. Cl. CPC G06Q 30/0627; G06F 40/20; G06N 20/00

(57) ABSTRACT

To improve attribute prediction for items, item categories are associated with a schema that is augmented with additional attributes and/or attribute labels. Items may be organized into categories and similar categories may be related to one another, for example in a taxonomy or other organizational structure. An attribute extraction model may be trained for each category based on an initial attribute schema for the respective category and the items of that category. The extraction model trained for one category may be used to identify additional attributes and/or attribute labels for the same or another, related category.

### BACKGROUND

This disclosure relates generally to computer hardware and software for attribute prediction, and more specifically to determining attributes and attribute values for item categories.

Accurate description of item attributes is important for many purposes. Such attributes may be used to structure data for various purposes, such as item search or relevance determination of an item to a query. However, particularly difficult challenges arise in determining applicable attributes or attribute values with automated computer prediction (e.g., via trained computer models) of attributes based on dynamic, freeform, unstructured, or unpredictable text, especially when limited (or no) training data is available. As an example, information about a physical product (e.g., grocery items) may include some specified information, such as a name or an item category, but may lack definition of additional attributes that may be used to distinguish different individual items, such as ingredient information, source information, fat content, or dietary information (e.g., whether the product is non-fat or gluten free). While various types of models have been developed to determine or predict attribute values for items (e.g., based on their description), such models typically rely on a defined set of attributes and attribute values (e.g., labels) that the item may be labeled with. Such attributes and values for a particular item may themselves be difficult to automatically identify, and typically may involve significant manual evaluation and labeling of products to determine appropriate attributes and values for a given category of products, which may be time intensive and may require domain expertise that is in short supply.

### SUMMARY

In accordance with one or more aspects of the disclosure, attributes and attribute values for a category may be represented as an attribute schema describing the attributes and the identified attribute values for the category. To identify attributes and attribute values for a category, an initial attribute schema may be generated with relatively high-confidence information, for example based on human labeling, structured information about items in the category (e.g., specified fields for an item), external data sources, etc. Using the initial attribute schema, an attribute extraction model may be trained with products in the category to predict the likely location of attribute values in a text string for an item in that category. The trained attribute extraction model may learn, based on the relatively high-confidence initial attribute information, the types of terms and location of such terms to contextually identify likely attribute values in the text string.

The trained attribute extraction model for a category may then be applied to items of that category to infer additional attribute values. In addition, the trained attribute extraction model for a first category may be applied to items in a second category and then, based on the predicted likelihood or frequency of attribute values in items of the second category (as predicted by the extraction model of the first category), identify additional attributes and/or attribute values for the second category. After determining additional attributes or attribute values for items in a category, they then may be used to augment the attribute schema of the category and/or provide additional attributes and attribute values to be identified in items of the category, enabling further labeling and improved use of the items based on the additional attribute labels. For example, further item evaluation or search may be improved by the additional attributes determined in the augmented attribute schema.

### BRIEF DESCRIPTION OF THE DRAWINGS

FIG. 1 is a block diagram of a system environment in which an online system operates, such as an online concierge system, according to one or more embodiments.

FIG. 2 illustrates an environment of an online platform, such as an online shopping concierge system, according to one or more embodiments.

FIG. 3 is a diagram of an online shopping concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 shows an example generation of category schemas augmented with related category information, according to one or more embodiments.

FIG. 6 shows an example process for augmenting a category attribute schema, according to one or more embodiments.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

System Architecture

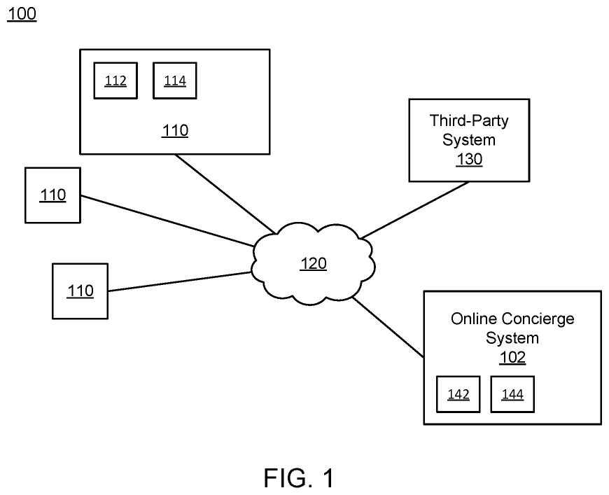

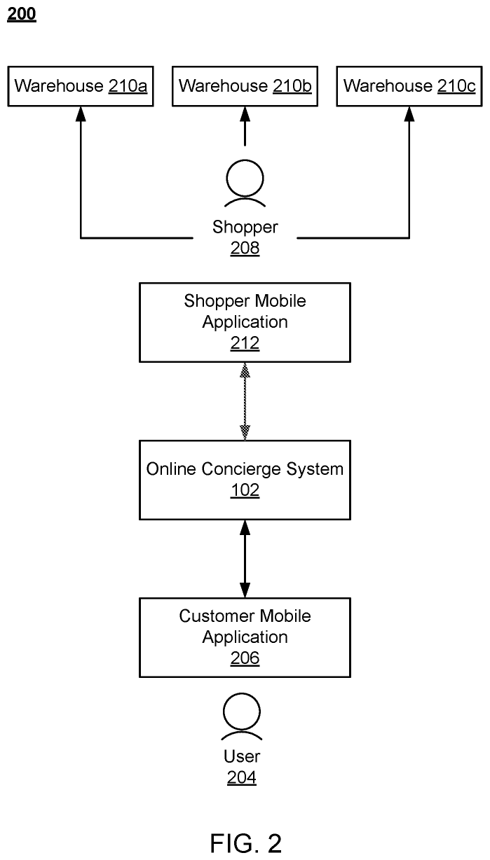

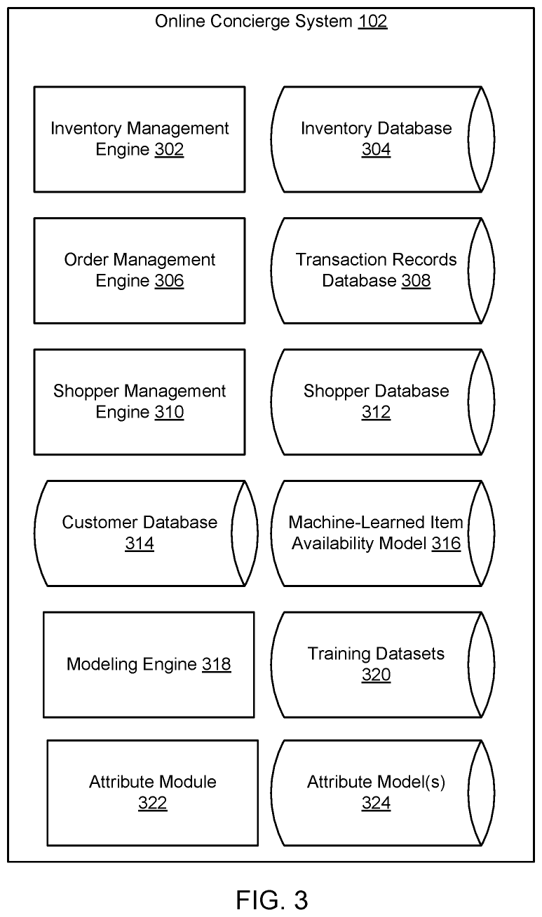

FIG. 1 is a block diagram of a system environment 100 in which an online system operates, such as an online concierge system 102, as further described below in conjunction with FIGS. 2 and 3, according to one or more embodiments. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

The online concierge system 102 may extract attribute values for various attributes of items to further structure information about the items, which may then be used for various purposes, such as automated attribute prediction or downstream processing, filtering, relevance determination, and so forth. The set of attributes and respective attribute values for a category is referred herein to as an attribute schema for a category. The attribute schema refers to the respective attributes and attribute values determined for items in a category, and in various embodiments may or may not be expressly generated or stored as a data structure. The online concierge system 102 is one example of a system that may determine attributes and attribute values for items as discussed herein. For certain items, attribute values may be known, e.g., provided in additional data about the item, while for other items, the attribute values may be inferred or extracted by the online concierge system 102. Attribute values may be extracted for items for which there is unstructured data (e.g., free text) that typically does not expressly describe whether the item has a particular attribute (or a value thereof). Rather, the item is associated with item data that includes unstructured data as a text string (or that may be converted to a text string) that describes the item. In the examples discussed below, the items are typically products listed in conjunction with the online concierge system 102, and the item data includes a textual description of the product as further discussed below. The principles discussed herein are applicable to additional types of items (e.g., other types of objects that may be analyzed for further attributes and attribute values as discussed herein) and by different types of systems in various embodiments.

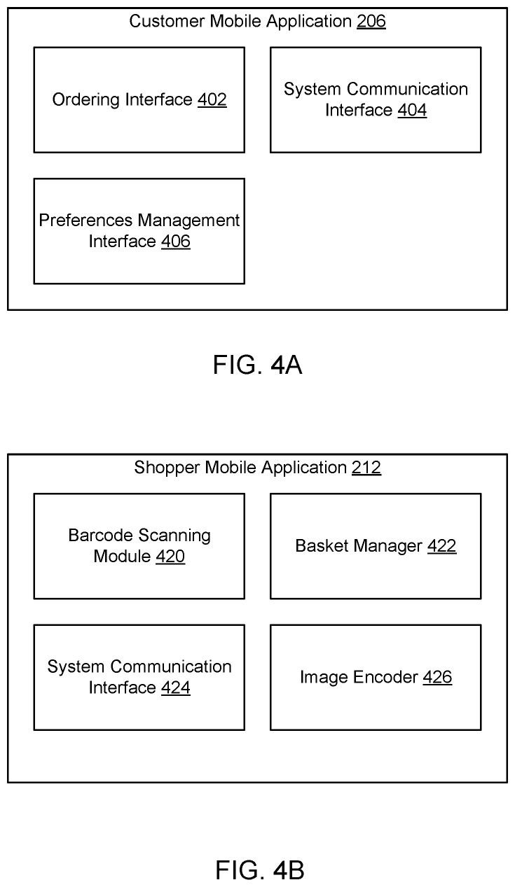

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online concierge system 102 or with the one or more client devices 110. In one embodiment, a third-party system 130 is an application provider communicating information describing applications for execution by a client device 110, or communicating data to client devices 110 for use by an application executing on the client device. In other embodiments, a third-party system 130 provides content or other information for presentation via a client device 110. For example, the third-party system 130 stores one or more web pages and transmits the web pages to a client device 110 or to the online concierge system 102. The third-party system 130 may also communicate information to the online concierge system 102, such as advertisements, content, or information about an application provided by the third-party system 130.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below that, when executed by the processor 142, cause the processor to perform the described functionality. For example, the memory 144 has instructions encoded thereon that, when executed by the processor 142, cause the processor 142 to determine attributes and attribute values for item categories. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device 110, a third-party system 130, or the online concierge system 102 may be special-purpose computing devices configured to perform specific functions as further described below, and may include specific computing components such as processors, memories, communication interfaces, and the like.

### System Overview

FIG. 2 illustrates an environment 200 of an online platform, such as an online concierge system 102, according to one or more embodiments. The figures use like-reference numerals to identify like-elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users 204. Each shopper 208 fulfills an order received from the online concierge system 102 at one or more warehouses 210, delivers the order to the user 204, or performs both fulfillment and delivery. In one embodiment, shoppers 208 make use of a shopper mobile application (SMA) 212, which is configured to interact with the online concierge system 102.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and quantitative information about the items, including size, color, weight, stock keeping unit (SKU), serial number, and so on. In one embodiment, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not-found (a shopper looked for the item but could not find it), the rate at which the item is found, and the popularity of the item.

For each item, the inventory database 304 identifies one or more attributes of the item and any corresponding values (i.e., attribute values) for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items. In various embodiments, the attributes may be provided by or may be based on information specified by a warehouse, item catalog, or other external source.

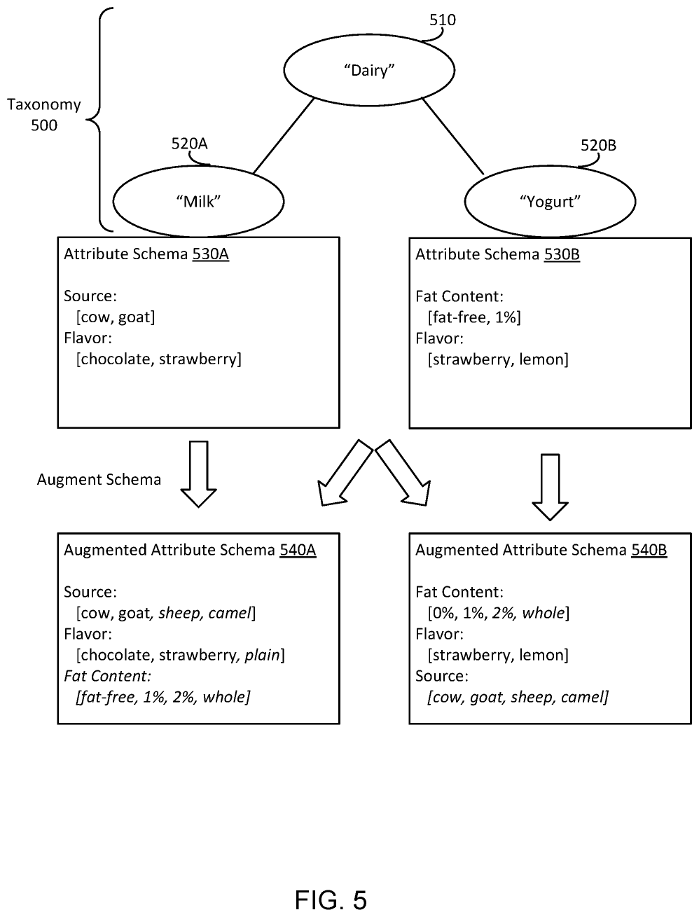

In additional embodiments, attributes to be used for characterizing items and/or the particular attribute values for an attribute of an item (e.g., a product) may be extracted, predicted, or inferred by a computer model of the online concierge system 102. In various embodiments, the attributes for an item may be based on a set of attributes and associated attribute values identified for items in an associated category. That is, each category of item (an item category) may have an associated set of attributes used to characterize items in that category. Each attribute for a category may have different values that may differ across different item categories. For example, the attribute “flavor” for the item category “Yogurt” may include items having attribute values of [non-flavored, strawberry, peach], while the “flavor” attribute for the item category “snack bar” may have items with attribute values of [granola, raisin, chocolate]. The different attributes and associated attribute values may be described as an attribute schema as further discussed in FIG. 5. The attribute module 322 may use one or more attribute models 324 for identifying the set of attributes and attribute values for item categories, which may include expanding or augmenting an initial set of attributes/attribute values. In addition, the attribute module 322 may determine (e.g., predict or infer) individual attribute values of an item for the attributes associated with the item's category.

In some examples, the attribute models 324 may include attribute extraction models that are configured to extract attribute values from a text string associated with an item. For some items, a text string associated with the item (e.g., formed based on an item description) may include a portion of the text that can be extracted as the attribute value by the attribute module 322 using an attribute model 324. For instance, a text string describing an item as: “Delicious hard cheese aged 18 months sourced from Netherland cows” may be processed to extract the attribute value “18 months” for the attribute “age” in the associated item category of “cheese.” In one embodiment, the location of attribute values (e.g., for known attribute values) may be used to train models for extracting additional attribute values from items having unknown attribute values for an attribute.

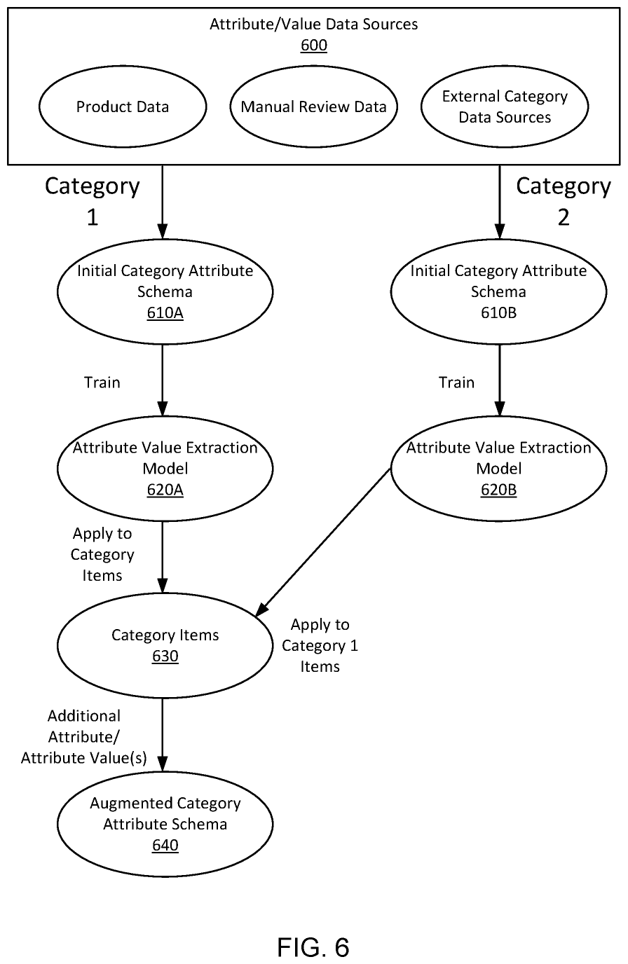

The extracted attribute values may be used to inform the set of attribute values that may be assigned to the attribute or that may be used for predicting attribute values that are not expressly mentioned in the item's text. For example, in some cases, dietary attributes of food items, such as whether it has gluten or is gluten-free, may be explicitly mentioned in text associated with an item, such as in the description of the item. In other cases, this attribute is not expressly mentioned or set in the item's listing. This attribute may be predicted based on the content of the text string and possible attribute values (such as “has gluten” and “gluten-free”) as labels for the item based on the text string. As such, item attribute values may be determined by the attribute module 322, identifying (or “extracting”) attribute values from a text string that may label or describe the attribute and attribute values, may also be determined by a prediction or inference for an item based on a set of attribute values for that particular item. These processes for determining the attributes and associated set of attribute values for a category is further discussed at FIGS. 5-6.

In addition, the set of attribute values for an attribute may be used as candidate labels for prediction of a particular item (e.g., when no attribute value is directly extracted for the item). Thus, in some embodiments, the attribute module 322 of the online concierge system 102 determines (e.g., predicts or infers) attributes based on information about the item. This may be used to supplement or add information to the items. For example, a grocery item may have a name “Almond Milk” and a textural description “Pure Almond-derived Milk, no additives and never concentrated” and may otherwise not be provided with additional attributes that may be relevant to the item, such as its type, whether it is nut-free or dairy-free, and so forth. In some embodiments, the attribute module 322 may use a model, such as a language model, to predict an attribute value for an attribute from the set of attribute values of the attribute. The models used for attribute value prediction may vary in different embodiments. In one example, the language model may be a masked language model for predicting an attribute value for attributes based on text associated with the items. The masked language model may mask a value in a text string or construct a query based on text associated with an item and use predicted values, as described, for example, in U.S. application Ser. No. 17/855,799, filed Jul. 1, 2022, the contents of which are incorporated by reference in their entirety. These attributes may include, for example, characteristics of the item that may be mutually exclusive classifications, such as its type (e.g., whether the item is a fruit, vegetable, meat, fish, etc.), or its nutritional characteristics (e.g., zero fat, low-fat, or not reduced fat). Attributes may also describe characteristics that may relate to Boolean characteristics, such as whether a product has a specific feature, property, ingredient, etc. For food items, this may include, for example, whether an item is gluten-free, dairy-free, nut-free, and so forth. After attribute value determination (e.g., by labeling, extraction, or prediction), the attribute values may be associated with the items in the inventory database 304 and may be designated according to how they were determined (e.g., as labeled, extracted, or inferred). For example, when a user searches for “dairy-free” items, the online concierge system 102 may indicate to the user which items are dairy-free based on information provided by a supplier or manufacturer, and which items are predicted to be dairy-free (but for which a user may wish to confirm based on the user's inspection of the item).

Though generally discussed in the context of products or items, the attribute determination and prediction discussed herein may generally be applied to other types of items for which information is available and may be processed by the discussed approaches.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210. Different levels in the taxonomy may provide different levels of specificity about the items included in the levels. In various embodiments, the taxonomy identifies a category and associates one or more specific items with a specific category. For example, a category identifies “milk,” and the taxonomy associates identifiers of different milk items (e.g., milk offered by different brands, milk having one or more different attributes, etc.) with that category. Thus, the taxonomy maintains associations between a category and specific items offered by the warehouse 210 matching the identified category. In some embodiments, different levels in the taxonomy identifies items with differing levels of specificity based on any suitable attribute or combination of attributes of the items. For example, different levels of the taxonomy specify different combinations of attributes for items, so items in lower levels of the hierarchical taxonomy have a greater number of attributes corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

The online concierge system 102 also includes an order management engine 306, which is configured to synthesize and display an ordering interface to each user 204 (for example, via the customer mobile application 206). The order management engine 306 is also configured to access the inventory database 304 to determine which products are available at which specific warehouse 210. The order management engine 306 may supplement the product availability information from the inventory database 304 with an item availability predicted by a machine-learned item availability model 316. The order management engine 306 determines a sale price for each item ordered by a user 204. Prices set by the order management engine 306 may or may not be identical to other prices determined by retailers (such as a price that users 204 and shoppers 208 may pay at the retail warehouses). The order management engine 306 also facilitates any transaction associated with each order. In one embodiment, the order management engine 306 charges a payment instrument associated with a user 204 when he/she places an order. The order management engine 306 may transmit payment information to an external payment gateway or payment processor. The order management engine 306 stores payment and transactional information associated with each order in a transaction records database 308.

In various embodiments, the order management engine 306 generates and transmits a search interface to a client device 110 of a user 204 for display via the customer mobile application 206. The order management engine 306 receives a query comprising one or more terms from a user 204 and retrieves items satisfying the query, such as items having descriptive information matching at least a portion of the query made by the user 204. In various embodiments, the order management engine 306 leverages item embeddings for items to retrieve specific items based on a received query. For example, the order management engine 306 generates an embedding for a query and determines the measures of similarity between the embedding for the query and item embeddings for various items included in the inventory database 304.

In addition, the order management engine 306 may use attributes, including predicted or inferred attributes by the attribute module 322, for scoring, filtering, or otherwise evaluating the relevance of items as responsive to the order query. As such, the attributes predicted (i.e., inferred) by the attribute module 322 may be added to the inventory database 304 and used to improve various further uses and processing of the item information, of which an order query is one example. In general, the additional attributes of an item that may be predicted by the attribute module 322 may be used for a variety of purposes according to the particular embodiment, type of item, predicted attributes, etc.

To use attributes for an order query, attributes relevant to the order query may be determined from the order query. The attributes may be explicitly designated or may be inferred from the order or from the user placing the order. For example, an order query may provide a text search for “milk” and specify that results to the query should include only items with the attribute “dairy-free.” In other examples, the user may be associated with dietary restrictions or other attribute preferences and indicate that the online concierge system 102 may automatically apply these preferences to queries or orders from that user.

The attributes associated with the query may specify whether an attribute is required, preferred, or should be excluded, and the order management engine 306 may filter and rank resulting items based on whether the item is associated with the attributes of the query. For example, the “dairy-free” attribute in the query may permit the order management engine 306 to exclude items which are not explicitly listed as dairy-free or predicted to have that attribute. The order management engine 306 may then score and rank items and provide the items to the user responsive to the query. For items that were predicted to have a desired attribute by the attribute module 322, in some embodiments, the user may be provided with an indication that the attribute was a prediction based on other information about the item so that the user can confirm whether the item satisfies the attribute and may not rely exclusively on the prediction. This may be particularly important, for example, when users provide dietary restrictions such as “nut-free” so that users may confirm the item is appropriate for the user's request.

In some embodiments, the order management engine 306 also shares order details with warehouses 210. For example, after successful fulfillment of an order, the order management engine 306 may transmit a summary of the order to the appropriate warehouses 210. The summary may indicate the items purchased, the total value of the items, and in some cases, an identity of a shopper 208 and a user 204 associated with the transaction. In one embodiment, the order management engine 306 pushes the transaction and/or order details asynchronously to associated retailer systems. This may be accomplished via use of webhooks, which enable programmatic or system-driven transmission of information between web applications. In another embodiment, retailer systems may be configured to periodically poll the order management engine 306, which provides details of all orders which have been processed since the last poll request.

The order management engine 306 may interact with a shopper management engine 310, which manages communication with and utilization of shoppers 208. In one embodiment, the shopper management engine 310 receives a new order from the order management engine 306. The shopper management engine 310 identifies the appropriate warehouse 210 to fulfill the order based on one or more parameters, such as a probability of item availability determined by a machine-learned item availability model 316, the contents of the order, the inventory of the warehouses, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312, which stores information describing each shopper 208, such as his/her name, gender, rating, previous shopping history, and so on.

As part of fulfilling an order, the order management engine 306 and/or shopper management engine 310 may access a customer database 314 which stores information describing each user (e.g., a customer). This information could include each user's name, address, gender, shopping preferences, favorite items, stored payment instruments, and so on.

In various embodiments, the order management engine 306 determines whether to delay display of a received order to shoppers for fulfillment by a time interval. In response to determining to delay the received order by a time interval, the order management engine 306 evaluates orders received after the received order and during the time interval for inclusion in one or more batches that also includes the received order. After the time interval, the order management engine 306 displays the order to one or more shoppers via the shopper mobile application 212; if the order management engine 306 generated one or more batches including the received order and one or more orders received after the received order and during the time interval, the one or more batches are also displayed to one or more shoppers via the shopper mobile application 212.

### Machine Learning Models—Item Availability

The online concierge system 102 further includes a machine-learned item availability model 316, a modeling engine 318, and training datasets 320. The modeling engine 318 uses the training datasets 320 to generate one or more machine-learned models, such as the machine-learned item availability model 316. The machine-learned item availability model 316 can learn from the training datasets 320, rather than follow only explicitly programmed instructions. The inventory management engine 302, order management engine 306, and/or shopper management engine 310 can use the machine-learned item availability model 316 to determine a probability that an item is available at a warehouse 210. The machine-learned item availability model 316 may be used to predict item availability for items being displayed to a user, selected by a user, or included in received delivery orders. The machine-learned item availability model 316 may be used to predict the availability of any number of items.

The machine-learned item availability model 316 can be configured to receive, as inputs, information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about that warehouse. A particular item at a particular warehouse may be identified using an item identifier and a warehouse identifier. In other embodiments, the item identifier refers to a particular item at a particular warehouse, so that the same item at two different warehouses is associated with two different identifiers unique to the two warehouses. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the machine-learned item availability model 316.

The machine-learned item availability model 316 contains a set of functions generated by the modeling engine 318 from the training datasets 320 that relate the item, warehouse, timing information, and/or any other relevant inputs, to the probability that a particular item is available at a particular warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be an error or uncertainty score of the output availability probability and may be calculated using any standard statistical error measurement. In some examples, the confidence score is based, in part, on whether the item-warehouse pair availability prediction was accurate for previous delivery orders (e.g., if the item was predicted to be available at the warehouse and was not found by the shopper or predicted to be unavailable but found by the shopper). In some examples, the confidence score is based, in part, on the age of the data for the item, e.g., if availability information has been received within the past hour, or the past day. The set of functions of the machine-learned item availability model 316 may be updated and adapted following retraining with new training datasets 320. The machine-learned item availability model 316 may be any machine-learning model, such as a neural network, boosted tree, gradient boosted tree, or random forest model. In some examples, the machine-learned item availability model 316 is generated from XGBoost algorithm.

The item probability generated by the machine-learned item availability model 316 may be used to determine instructions delivered to the user 204 and/or shopper 208, as described in further detail below.

The training datasets 320 includes training data from which the machine-learned models may learn parameters, such as weights, model structure, and other aspects for developing predictions. For the machine-learned item availability model 316, the training datasets 320 may relate a variety of different factors to known item availabilities from the outcomes of previous delivery orders (e.g., if an item was previously found or previously unavailable). The training datasets 320 includes the items included in previous delivery orders, whether the items in previous delivery orders were picked, the warehouses associated with the previous delivery orders, and a variety of characteristics associated with each of the items (which may be obtained from the inventory database 304). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weigh these factors differently, where the weights are a result of a “learning” or training process on the training datasets 320. The training datasets 320 are very large datasets taken across a wide cross-section of warehouses, shoppers, items, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of particular items, or restocking shipments may be received on particular days. In some embodiments, training datasets 320 include a time interval since an item was previously picked in a previously delivered order. If a particular item has recently been picked at a warehouse, this may increase the probability that it is still available. If there has been a long time interval since a particular item has been picked, this may indicate that the probability of that item being available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between the time information and item availability are determined by the modeling engine 318 training a machine-learning model with the training datasets 320, producing the machine-learned item availability model 316.

The training datasets 320 includes item characteristics. In some examples, the item characteristics include a department associated with the item. For example, if the item is yogurt, it is associated with the dairy department. The department may be categorized as the bakery, beverage, nonfood and pharmacy, produce and floral, deli, prepared foods, meat, seafood, dairy, or any other categorization of items used by the warehouse. The department associated with an item may affect item availability, since different departments have different item turnover rate and inventory levels. In some examples, an item's characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that included that particular item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger or smaller inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 318 training a machine-learning model with the training datasets 320, producing the machine-learned item availability model 316.

The training datasets 320 may include additional item characteristics that affect item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

### Machine Learning Models—Attributes

The training datasets 320 may include additional data for training additional computer models, such as an attribute value extraction model or value prediction model. The training datasets 320 for these models may include a corpus of language-related text. The models trained for attribute extraction and prediction and used by the attribute module 322 may include an attribute value extraction model and other types of models, such as a text-text model, as further discussed below. The training datasets 320 for language models may include example text representing typical or normal use of language and may include data collected from website crawlers (e.g., collecting web page information), books, magazines, encyclopedia entries, and/or other sources of language use that may indicate ways in which language and words (e.g., represented as text tokens) are used in practice. This training data may thus include example uses of language that may be used to train a language model to learn the use and relationship of individual words and context of words with respect to grammar and other terms within a portion of text, such as a text string. Each word may be represented as a text “token” in the language model.

In one embodiment, an attribute extraction model may be trained with training data that associates a portion of a text string (e.g., a product description) with extracted attributes for the item. For example, a text string describing an item as: “Delicious hard cheese aged 18 months sourced from Netherland cows” may be labeled with the portion “18 months” as designating an attribute value for the attribute “age” for an item in the cheese category. Different attributes may be labeled in different portions of the text string, such as “cow” as the animal source for the cheese, or “Netherland” as the country origin of the product. As such, the training data for attribute value extraction may include a number of text strings for items having labeled portions of the string and associated attribute values.

In one embodiment, a language model (such as a masked language model) may be used for predicting attribute values without directly extracting a portion of the text as the attribute value. In some embodiments, these models may be trained with training data that masks a portion of the input text and is trained to learn the masked portion of the input. For example, the training input may be “In autumn, the leaves fall to the ground,” in which the word “leaves” may be masked, such that the model is configured to predict the token that should replace the masked word in: “In autumn, the [MASK] fall to the ground.” While “leaves” was masked in the input (e.g., as training data) and may be the text token used as a positive training output, the model may also predict semantically and/or contextually similar text tokens that may be likely or possible terms, such as “apples” or “petals.” As such, a masked language model learns to accomplish a “fill-in-the-blank” task for replacing the masked term in an input with a text token. BERT (Bidirectional Encoder Representations from Transformers) is one example structure that may be used for a masked language model. The modeling engine 318 may train the attribute models 324 based on training instances from the corpus of language in the training datasets 320 and may also include item information such as item descriptive information from the inventory database 304. The modeling engine 318 may also further train or “fine-tune” parameters of the attribute models 324 based on training instances of attribute queries as further discussed below.

### Customer Mobile Application

FIG. 4A is a diagram of the customer mobile application (CMA) 206, according to one or more embodiments. The CMA 206 includes an ordering interface 402, which provides an interactive interface with which the user 204 can browse through and select items/products and place an order. The CMA 206 also includes a system communication interface 404 which, among other functions, receives inventory information from the online shopping concierge system 102 and transmits order information to the online concierge system 102. The CMA 206 also includes a preferences management interface 406, which allows the user 204 to manage basic information associated with his/her account, such as his/her home address and payment instruments. The preferences management interface 406 may also allow the user 204 to manage other details such as his/her favorite or preferred warehouses 210, preferred delivery times, special instructions for delivery, and so on.

### Shopper Mobile Application

FIG. 4B is a diagram of the shopper mobile application (SMA) 212, according to one or more embodiments. The SMA 212 includes a barcode scanning module 420 which allows a shopper 208 to scan an item at a warehouse 210 (such as a can of soup on the shelf at a grocery store). The barcode scanning module 420 may also include an interface which allows the shopper 208 to manually enter information describing an item (such as its serial number, SKU, quantity and/or weight) if a barcode is not available to be scanned. SMA 212 also includes a basket manager 422, which maintains a running record of items collected by the shopper 208 for purchase at a warehouse 210. This running record of items is commonly known as a “basket.” In one embodiment, the barcode scanning module 420 transmits information describing each item (such as its cost, quantity, weight, etc.) to the basket manager 422, which updates its basket accordingly. The SMA 212 also includes a system communication interface 424, which interacts with the online concierge system 102. For example, the system communication interface 424 receives an order from the online concierge system 102 and transmits the contents of a basket of items to the online concierge system 102. The SMA 212 also includes an image encoder 426, which encodes the contents of a basket into an image. For example, the image encoder 426 may encode a basket of goods (with an identification of each item) into a quick response (QR) code which can then be scanned by an employee of the warehouse 210 at check-out.

### Determining Attributes and Attribute Values for Item Categories

FIG. 5 shows an example generation of category schemas augmented with related category information, according to one or more embodiments. As noted above, items may be categorized into various types of items, which may be related to one another in various ways, such as the taxonomy 500 shown in FIG. 5. Though a hierarchical structure of item categories is shown here, in which a parent node 510, here having the category “Dairy,” has two child nodes 520A-B, here having the categories “Milk” and “Yogurt”, different types of structures indicating relatedness of item categories may also be used. In general, each item category may be associated with an attribute schema 530 that describes the attributes and attribute values of attributes for that item category. The attribute schema in various embodiments may be a discrete data structure that lists the attributes and attribute values for items in the category; in other embodiments, the attribute schema is used herein as a representation for the attributes and associated attribute values associated with items in the category, without an express data structure representing the attributes and attribute values. As such, while generally discussed herein as a data structure for convenience of explanation, an attribute schema (such as attribute schemas 530A-B or augmented attribute schemas 540A-B) may be an emergent property of the attribute information (e.g., particular attributes and attribute values) associated with items in the category. For example, the attribute schema may represent identifying unique (i.e., de-duplicated) attributes and associated attribute values of items within an item category. The attribute values in an attribute schema may describe the “possible” attribute values for items in the category that may be used for various further purposes, such as the candidate values/classes for automated inference or prediction of attribute values for items in a category, for inclusion as parameters for search and filtering of items based on attributes and attribute values, and for other item labeling, filtering, labeling, selection, and processing tasks.

In many cases, determining a complete attribute schema for item categories (and then identifying particular attribute values for individual items) may be challenging, as items may be labeled with certain attributes but not labeled with others, and it may be difficult to automatically determine a complete set of attribute values from incomplete data or to use attribute schema for training computer models to successfully label items with attribute values when the existing attribute schema for an item category is incomplete or erroneous. To improve the attribute schema 530 for an item category, the attribute schema may be augmented with attributes and/or attribute values based on attribute schema of related item categories. In the example shown in FIG. 5, the attribute schema 530A is augmented to generate augmented attribute schema 540A by augmenting attributes and values based on items in its own category (e.g., from items in the “milk” category, as well as from items in related categories, such as from the “yogurt” category).

Shown in the example of FIG. 5, the “milk” category has an attribute schema 530A (which may also be termed an “initial” attribute schema) that may be determined for the category based on relatively high-confidence information, such as previously-labeled items in the category (e.g., based on external data sources), from external data sources related to the categories, or from expert-provided definitions). In the example of FIG. 5, the attribute schema 530A for the “milk” category has two attributes, a “source” attribute having attribute values [cow, goat] and a “flavor” attribute having attribute values [chocolate, strawberry]. Similarly, the attribute scheme 530B for the item category “yogurt” has two attributes, a “fat content” attribute having attribute values [fat-free, 1%] and a “flavor” attribute having attribute values [strawberry, lemon]. As shown in these examples, the attribute schema for different categories may include different attributes, and when both attribute schemas include the same attribute name (e.g., the “flavor” attribute), the attribute values for the same attribute may differ in each attribute schema.

Using the initial attribute schemas (e.g., those based on relatively high-confidence information), attribute value models may be trained to identify or extract attribute values for the respective item category. As such, an attribute value model may be trained to recognize attributes for the category “milk” based on the associated attribute schema 530A and text strings associated with items in the “milk” category. Similarly, another attribute value model may be trained for the attribute schema 530B based on the items in the “yogurt” category. To find additional attributes and attribute values for the attribute schemas, the trained attribute value extraction model(s) of a category and/or of a related category may be applied to items in the category (e.g., those without labeled attribute values for a particular attribute) to determine additional attributes and attribute values to be added to the initial category attribute schema to generate the augmented category attribute schemas 540A-B. As shown in FIG. 5, information based on the attribute schema 530A may be used to augment attribute schema 530B and vice versa. That is, the attribute value extraction models trained on attribute schema for one category may be applied to a related category to identify additional attributes and/or attribute values for that category. Stated another way, an initial attribute schema 530A may be augmented based on an attribute value extraction model trained on its items in its category (based on attribute schema 530A) and may also be augmented based on an attribute value extraction model trained on items in a related category (based on attribute schema 530B). Item categories used for augmenting an attribute schema may be based on a structure relating item categories, such as a taxonomy 500 or other structured category relationship, or may be based on similarly or another measure of relatedness of item categories. For example, a relatedness of item categories may be scored based on similarity of attributes or other values of items in the categories, similarity of text describing the items, co-interaction (e.g., co-purchase), or other information describing similarity of items in different categories, and so forth. When the relatedness (e.g., a relatedness score) exceeds a threshold, the categories may be considered as related for augmenting an attribute schema with information based on the related schema. The process for augmenting attribute schemas is further discussed in FIG. 6.

As shown in FIG. 5, the attribute schema 530A is augmented with additional attribute values [sheep, camel] for the attribute “Source” and with an additional attribute “Fat Content.” By augmenting the attribute schemas 530, subsequent processes may benefit from more complete information for items in various categories, improving item labeling, selection, processing, and so forth.

FIG. 6 shows an example process for augmenting a category attribute schema, according to one or more embodiments. The process of FIG. 6 may be used to augment an attribute schema with additional attribute values and/or attributes (i.e., different types of attributes), which may include the use of models trained on information from another category. This process, in one embodiment, may be performed by the attribute module 322, and may be performed by different systems in various embodiments. In the example of FIG. 6, the process illustrates the generation of an augmented category attribute schema 640 for a first category; similar processes may be used for augmenting additional category attribute schemas, for example for a second category or for many categories.

As also discussed with respect to FIG. 5, an initial category attribute schema 610A-B may be generated for categories based on a set of relatively high-confidence information. This data may take different forms in different embodiments and may include various attribute/value data sources 600 that may each be used alone or in combination with other sources. As shown in FIG. 6, such sources may include product data, manual review data, and external data sources. In instances where the item information is provided from external systems (e.g., products loaded from external catalogs, warehouses, etc.), the product data represents attributes and attribute values as structured and provided by these systems. For example, an item may be provided from an external source with various structured data, such as in a markup language like XML, designating individual fields and values of an item, which may represent item attributes and associated attribute values for that item. The specified attributes and attribute values may then be used to populate the initial attribute schema based on the item-specific information. Similarly, manual review data may represent designation of attributes and attribute values for items which may be based on expert or manual human review of the item to identify its attributes and attribute values. The manual review may also include review and determination of relevant attributes and related attribute values for an initial category attribute schema of an item category directly (e.g., without specifically associating attribute values with individual items). This manual review may be performed for a subset of the total items for the category, such that the attribute information for many items may not be known, and the attributes and/or attribute values may be incomplete or subject to change. As such, the manual review of data for the initial category attribute schema 610 may be used to provide initial data that may initialize or bootstrap further schema augmentation. In addition, additional external data sources related to the category itself may provide attribute and attribute value information for an initial category attribute schema. External data sources, such as dictionaries or other publicly-available information may be processed to automatically identify attributes and/or attribute values that may be appropriate for a category. For example, the name of a category (e.g., “cheese”) may be used to identify a matching entry in a database, encyclopedia, etc., and information about the category may be automatically parsed/processed to identify properties of the category that may vary. For example, the entry for “cheese” may include a definition such as “a cheese is made from an animal's milk, such as a cow or goat, and is typically aged for a minimum or one month to several years.” Such definitional sentences may be identified, for example, by identifying the name of the category with “is” and identifying attributes that may vary with different attribute values by language suggesting variation or value ranges for properties in the following sentence(s). The text “such as” or “for example” or other language suggesting different values for an attribute (or other lists of values) may be used to automatically populate an attribute and attribute values for the category. Here, for example, the processing may identify “animal's milk” as having possible attribute values “cow” or “goat” from the description, along with “aged” with values “one month” and “several years.” The terms indicating values and ranges may be identified with various text processing approaches, such as string matching or regular expressions.

The attributes and attribute values that are determined automatically (e.g., from product data or external category data sources) may be further processed by manual review, for example, to modify the attributes or add additional attribute values applicable to the category. As such, the initial category attribute schema 610 for each category (e.g., the initial category attribute schemas 610A-B) may be generated automatically based on item or category description data and may include manual generation or review/fine-tuning. As discussed above, however, the initial category attribute schemas may be incomplete with respect to attributes and/or attribute values and may be further augmented to generate an augmented category attribute schema 640 as discussed below.

To augment the attribute schemas, an attribute value extraction model 620 may be generated for each category based on the initial category attribute schema 610, for example, to generate respective attribute value extraction models 620A, 620B for a first category and second category respectively. The attribute value extraction model 620 is a model that extracts one or more attribute values from a text string associated with an item in the category. The specific structure of the attribute value extraction model 620 and its training and parameter determination may vary in different embodiments. In general, the attribute value extraction model 620 may receive a text string associated with the item (e.g., an item description, which may be supplemented with additional fields describing the item) and output a set of attributes and attribute values for the attributes identifiable for the item from the text string. As one example, given an item in the “milk” category having the text string description “A delicious cow's milk with 2% reduced fat and hearty chocolate flavor, this is a healthy and tasty treat for young and old” for the attribute schema 530A, the attribute value extraction model 620 may identify the attribute values “cow” and “chocolate” for attributes “source” and “flavor,” respectively. In some embodiments, rather than matching the attribute values of an existing attribute schema (e.g., using the attribute values as a target label), the attribute value extraction model may identify a start and stop portion of the text string as a likely attribute value of the item for the attribute. In these embodiments, the attribute value extraction model may identify attribute values that differ from the attribute values in the pre-existing schema, as further discussed below.

As one example of an attribute value extraction model 620, an attribute value extraction model may be generated based on the initial category attribute schema 610 by identifying one or more strings that are associated with an attribute or attribute value in a text string. In one example, a set of strings indicative of an attribute value may be identified, such that each attribute value is associated with one or more strings. The value extraction model may match strings of the attribute value with portions of an item's text string to identify the associated attribute value for the item. Similarly, in various embodiments, the attribute values may be identified using pattern or regular-expression (regex) matching. In one embodiment, the strings to match and pattern matches may be based in part on the labels for the items in that category.

In another example, training data may be generated by labeling items in the category and the respective text strings with attribute values of the initial category attribute schema 610. These portions of the text strings corresponding to the attribute values may then be used to form a training set for a language model configured to identify and extract attribute values from text strings. Continuing the example from above, the item description “A delicious cow's milk with 2% reduced fat and hearty chocolate flavor, this is a healthy and tasty treat for young and old” may be labeled to indicate the portions of the description corresponding to respective attributes: “A delicious [[cow's]] milk with 2% reduced fat and hearty [[chocolate]] flavor, this is a healthy and tasty treat for young and old.” These labels may be used to generate a set of training data of item descriptions and identified portions relating to attributes. A language-based attribute value extraction model 620 may then be trained on this data to learn the particular text (e.g., text tokens), and context that may indicate the presence of a relevant attribute token. In one example, such a language model may be based on a bi-directional encoding language model, such as BERT, which may include a conditional random field (e.g., a BERT-CRF model). Such a language model may learn, based on the labeled examples, that contextual information, such as an animal-related modifiers before “milk” or the phrase “made from” signifies that the following terms may represent an attribute value for the “source” attribute. In various types of embodiments, different types of attribute value extraction models may be used, which generally identify the location of attribute values in a text string, and may be used to expand and further populate the possible attribute values for an attribute. As such, the attribute value extraction model 620 may be trained to identify the respective positions of attribute values for attributes within the text string of an item.

As such, after training, the attribute value extraction model 620A for the category may be applied to additional category items 630 in the first category. The attribute value extraction model 620A may then be used to identify additional attribute values present in the first category items, even when such attribute values were not part of the initial category attribute schema 610A. For example, when the attribute value extraction model 620 learns the location of attribute values based on context and other surrounding terms or the type of term that may signify an attribute value, the attribute value extraction model 620A may identify further attribute values for these additional items that differ from the attribute values in the initial category attribute schema 610A. In some embodiments, the additional attribute values identified by the attribute extraction model 620A may be further processed to determine whether to add the attribute values to the item and/or to the augmented category attribute schema 640. For example, the number of instances that a particular attribute value is identified or the proportion of items having the attribute value may be determined such that a threshold number or frequency of the attribute value may be required before adding the attribute value to the augmented category attribute schema 640 or associating the attribute value with the item(s).

In further embodiments, in addition to applying the attribute value extraction model 620A of the category to additional items in the category, the attribute value extraction model 620B of a related category (e.g., for a second item category) may also be applied to items of the first category. Though the category is different, and the item category differs, the attribute value extraction model 620B may be applied to items in the first category (e.g., category items 630) to determine whether the other category's attribute value extraction model 620B successfully identifies the location of attribute values within text strings of items in the first category. Because the initial category attribute schemas 610 may be incomplete, the related item categories may be used to inexpensively evaluate whether further attributes and attribute values may be identified in other item categories. In this example, the attribute value extraction model 620B of the second item category may be applied to items in the first category. For the categories of FIG. 5, for example, the attribute value extraction model trained for the category “Yogurt” based on attributes “fat content” and “flavor” (e.g., in the initial attribute schema 530B) may then be applied to items in the category “Milk.” When the attribute value extraction model trained for “Yogurt” is applied to items in the “Milk” category, the additional attribute “Fat Content” may be evaluated for the “Milk” category that was not present in the “Milk” attribute schema, and the contextual and other parameters for identifying relevant “flavor” attributes in the “Yogurt” category may be applied to the items in the “Milk” category. As a result, the similarity of the item categories enables attribute extraction of related categories to augment attributes and attribute values in another.

In some embodiments, the attributes and/or attribute values identified in a first category's items based on the application of another category's attribute extraction model are further processed before being included in the augmented category attribute schema 640. As one example, the proportion of items in the first category for which an attribute of another category is identified may be evaluated to determine whether the attribute of another category is automatically determined with sufficient frequency. In some examples, the attribute may be required to be identified in more than a threshold portion of items, such as 30%, 50%, or 70%, with the particular portion or percentage differing in various embodiments. Similarly, the extracted attribute values (when applying another category's attribute value extraction model) may be evaluated for similarity with attribute values of the first category. For example, when an attribute of the second category is shared for both categories, the application of the second category's attribute value extraction model 620B to the category items 630 of the first category should be expected to yield the known attribute values of that attribute for the first category, at least some portion of the time. In the example of a “flavor” attribute for the attribute schemas of FIG. 5, although the “flavors” for the “Milk” category includes [chocolate, strawberry] and in the “Yogurt” category includes [strawberry, lemon], identified attribute values of the Yogurt attribute value extraction model may be accepted if the Yogurt attribute value extraction model also identified a threshold number of “chocolate” attribute values in the Milk category, suggesting that the attribute value extraction model (trained on data for another category) correctly identifies known attribute values for attributes of the target (i.e., first) category.

As such, the attribute value extraction models for a category and for similar categories may be applied to items in that category to augment the initial attribute schema and identify additional attributes and attribute values for the category. The further identified attributes and attribute values may be further processed before addition to the augmented attribute schema, for example via further manual review, approval, or with review by further automated processes. The augmented attribute schema for a category may then be used for various further processing of items in the category, for example, to train models that predict the known attribute values as likely predicted, or inferred attribute values of items in the category, or for further item relevance, filtering, or search evaluation, among other purposes. In general, the augmented schemas for categories permits automated expansion of structured characterization of items in various categories and reduces what may typically be extensive human attribute determination (e.g., what attributes to use for a category) and attribute value determination (what values to use for an attribute in a given category).

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
accessing an attribute extraction model for a first item category, wherein the attribute extraction model is a machine-learning model that is trained to predict attribute labels for items in the first item category based on unstructured text strings describing the items in the first item category;
accessing unstructued text strings for one or more items in a second category;
predicting attribute labels for the one or more items in the second item category by applying the attribute extraction model to the unstructured text strings for the one or more items, wherein the predicted attribute labels for the one or more items in the second item category are selected from a set of attribute labels associated with the first item category;
augmenting a second attribute schema for the second item category by adding, to the second attribute schema for the second item category, at least one additional attribute label, wherein the at least one additional attribute label is selected based on the predicted attribute labels for the one or more items in the second item category; and
labeling items in the second item category based on the augmented second attribute schema.

2. The method of claim 1, further comprising identifying the second item category based on a relationship of the first item category to the second item category.

3. The method of claim 2, wherein the relationship of the first item category to the second item category is a shared parent node in a categorical taxonomy.

4. The method of claim 1, wherein the attribute extraction model is a Bidirectional Encoder Representations from Transformers-Conditional Random Field (BERT-CRF) model.

5. The method of claim 1, further comprising training the attribute extraction model to predict attribute labels by:
accessing a set of training examples for the attribute extraction model, wherein each training example comprises an unstructured text string for an item in the first category and attribute label for the item;
applying the attribute extraction model to the unstructured text string in each of the set of training examples to generate a label prediction for each training example;
comparing the label prediction for each training example to the corresponding attribute label for each training example using a loss function; and
updating a plurality of parameters of the attribute extraction model using a backpropagation process based on the comparisons of the label predictions and the corresponding attribute labels.

6. The method of claim 1, wherein the first or second attribute schema is determined based on text extracted from one or more item descriptions.

7. The method of claim 1, wherein the first or second attribute schema is determined based on an external data source.

8. The method of claim 1, wherein the second attribute schema is augmented with the at least one additional attribute label when a portion of the predicted attribute labels for the one or more items in the second item category exceeds a threshold.

9. The method of claim 1, wherein the second attribute schema is augmented with an additional attribute having the at least one additional attribute label.

10. The method of claim 1, further comprising augmenting the second attribute schema with another attribute label based on predicted attribute labels from another attribute extraction model for the second item category.

11. A computer program product comprising a non-transitory computer readable storage medium having instructions encoded thereon that, when executed by a processor, cause the processor to:
access an attribute extraction model for a first item category, wherein the attribute extraction model is a machine-learning model that is trained to predict attribute labels for items in the first item category based on unstructured text strings describing the items in the first item category;
access unstructued text strings for one or more items in a second category;
predict attribute labels for the one or more items in the second item category by applying the attribute extraction model to the unstructured text strings for the one or more items, wherein the predicted attribute labels for the one or more items in the second item category are selected from a set of attribute labels associated with the first item category;
augment a second attribute schema for the second item category by adding, to the second attribute schema for the second item category, at least one additional attribute label, wherein the at least one additional attribute label is selected based on the predicted attribute labels for the one or more items in the second item category; and
label items in the second item category based on the augmented second attribute schema.

12. The computer program product of claim 11, the instructions further causing the processor to identify the second item category based on a relationship of the first item category to the second item category.

13. The computer program product of claim 12, wherein the relationship of the first item category to the second item category is a shared parent node in a categorical taxonomy.

14. The computer program product of claim 11, wherein the attribute extraction model is a Bidirectional Encoder Representations from Transformers-Conditional Random Field (BERT-CRF) model.

15. The computer program product of claim 11, further having instructions encoded thereon that, when executed by a processor, cause the processor to:
access a set of training examples for the attribute extraction model, wherein each training example comprises an unstructured text string for an item in the first category and attribute label for the item;
apply the attribute extraction model to the unstructured text string in each of the set of training examples to generate a label prediction for each training example;
compare the label prediction for each training example to the corresponding attribute label for each training example using a loss function; and
update a plurality of parameters of the attribute extraction model using a backpropagation process based on the comparisons of the label predictions and the corresponding attribute labels.

16. The computer program product of claim 11, wherein the first or second attribute schema is determined based on text extracted from one or more item descriptions.

17. The computer program product of claim 11, wherein the first or second attribute schema is determined based on an external data source.

18. The computer program product of claim 11, wherein the second attribute schema is augmented with the at least one additional attribute label when a portion of the predicted attribute labels for the one or more items in the second item category exceeds a threshold.

19. The computer program product of claim 11, wherein the second attribute schema is augmented with an additional attribute having the at least one additional attribute label.

20. A system comprising:
a processor; and
a non-transitory computer readable storage medium having instructions encoded thereon that, when executed by the processor, cause the processor to:
access an attribute extraction model for a first item category, wherein the attribute extraction model is a machine-learning model that is trained to predict attribute labels for items in the first item category based on unstructured text strings describing the items in the first item category;
access unstructued text strings for one or more items in a second category;
predict attribute labels for the one or more items in the second item category by applying the attribute extraction model to the unstructured text strings for the one or more items, wherein the predicted attribute labels for the one or more items in the second item category are selected from a set of attribute labels associated with the first item category;
augment a second attribute schema for the second item category by adding, to the second attribute schema for the second item category, at least one additional attribute label, wherein the at least one additional attribute label is selected based on the predicted attribute labels for the one or more items in the second item category; and
label items in the second item category based on the augmented second attribute schema.
